(19) United States
(12) Patent Application Publication
(10) Pub. No.: US 2009/0167616 A1
(43) Pub. Date: Jul. 2, 2009

(54) Antenna Module, Speaker and Portable Electronic Device

(75) Inventor: Min-Che Chen, Taoyuan City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: HTC CORPORATION, Taoyuan City (TW)

(21) Appl. No.: 12/261,197

(22) Filed: Oct. 30, 2008

(30) Foreign Application Priority Data
Dec. 31, 2007 (TW) 096151405

(51) Int. Cl. H01Q 1/24; H01Q 9/04

(52) U.S. Cl. 343/702; 343/700 MS

(57) ABSTRACT

An antenna module, a speaker and a portable electronic device are provided, wherein the portable electronic device comprises the antenna module, the speaker and a circuit board. The antenna module comprises a main portion and a connecting portion, wherein the main portion of the antenna module comprises at least one portion of a metal shield of the speaker, and the connecting portion electrically connects the circuit board and the main portion.

This application claims priority to Taiwan Patent Application No. 096151405 filed on Dec. 31, 2007; the disclosure of which is incorporated herein by reference in its entirety.

### CROSS-REFERENCES TO RELATED APPLICATIONS

Not applicable.

### BACKGROUND OF THE INVENTION

1. Field of the Invention

The present invention relates to an antenna module, and particularly, relates to an antenna module for a portable electronic device.

2. Descriptions of the Related Art

Because portable electronic devices have become indispensable necessities for modern people's daily life, manufacturers have needed to integrate various communication functions into their portable electronic device products to increase the competitiveness of the product. Due to the difference between corresponding bandwidths, various communication modules such as Bluetooth (BT) modules, wireless LAN (WLAN) modules, various digital TV modules, such as digital video broadcasting (DVB) modules, and mobile communication modules may vary greatly in the respective transmitting/receiving signal bands that they require. However, by integrating various communication modules into a single portable electronic device, there is a need to install multiple antenna modules in the single portable electronic device. However, antenna modules require a certain volume to transmit and receive signals and to deliver a quality performance, the location thereof must be free from the communication interference of both the interior and exterior of the housing thereof. Consequently, a large receiving space is needed for the multiple antenna modules, and furthermore, the restrictions imposed by the location requirements will undoubtedly impede the possibility of providing a thin, slim and lightweight portable electronic device. It is also difficult to comply with the requirements on quality and cost of the final products.

To reduce the relatively large space required for the various antennal modules in a single housing, ceramic chip antennas have been adopted in the portable electronic devices. Because the ceramic chip antenna is highly integrable with circuit boards and has a smaller volume than that of a typical metal antenna, it is expected to reduce the receiving space occupied by this antenna module. Unfortunately, the ceramic chip antenna is made of a material with a high dielectric constant, so performances thereof in terms of the bandwidth, efficiency and gain are much inferior to those of typical metal antennas. Furthermore, the ceramic chip antenna requires a low temperature co-fired ceramic (LTCC) process which is quite complex and the technology thereof is immature. Consequently, the overall cost of the ceramic chip antenna is more than twice that of a typical metal antenna, making it more costly and less likely for the ceramic chip antenna to replace the metal antenna.

In view of this, it is highly desirable in the field to provide an antenna module that can be integrated with the housing, occupies little space, is at low cost, and has a large bandwidth, an increased efficiency and a high gain.

### SUMMARY OF THE INVENTION

One objective of this invention is to provide an antenna module for a portable electronic device and the portable electronic device itself. The antenna module is highly integrated, occupies little space, is at low cost, and has a large bandwith, an increased efficiency and a high gain. As a result, it is easier to manufacture a thin, slim and lightweight portable electronic device.

At least one metal shield of a speaker disposed in the portable electronic device is applied to the antenna module. The portable electronic device comprises an antenna module of this invention, a speaker and a circuit board. The speaker is disposed on the circuit board, and comprises at least one driver unit and at least one metal shield disposed above the at least one driver unit. The antenna module comprises a main portion and a connecting portion. The connecting portion electrically connects the circuit board and the main portion, while the main portion comprises at least one portion of the metal shield. In this way, the present invention prevents the disadvantages that result from using the conventional metal antennas or ceramic chip antennas.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a partial top view of a portable electronic device of this invention;

FIG. 2 is a partial cross-sectional view of a speaker in the portable electronic device of this invention;

FIG. 3 is a partial cross-sectional view of the first embodiment of an antenna module according to this invention; and

FIG. 4 is a partial cross-sectional view of the second embodiment of the antenna module according to this invention.

### DESCRIPTION OF THE PREFERRED EMBODIMENT

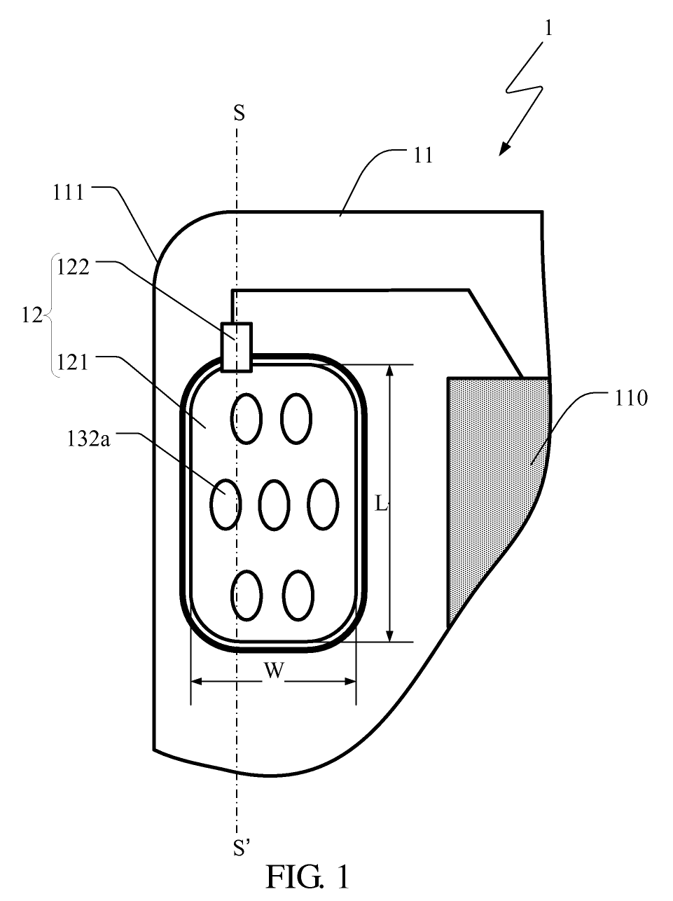

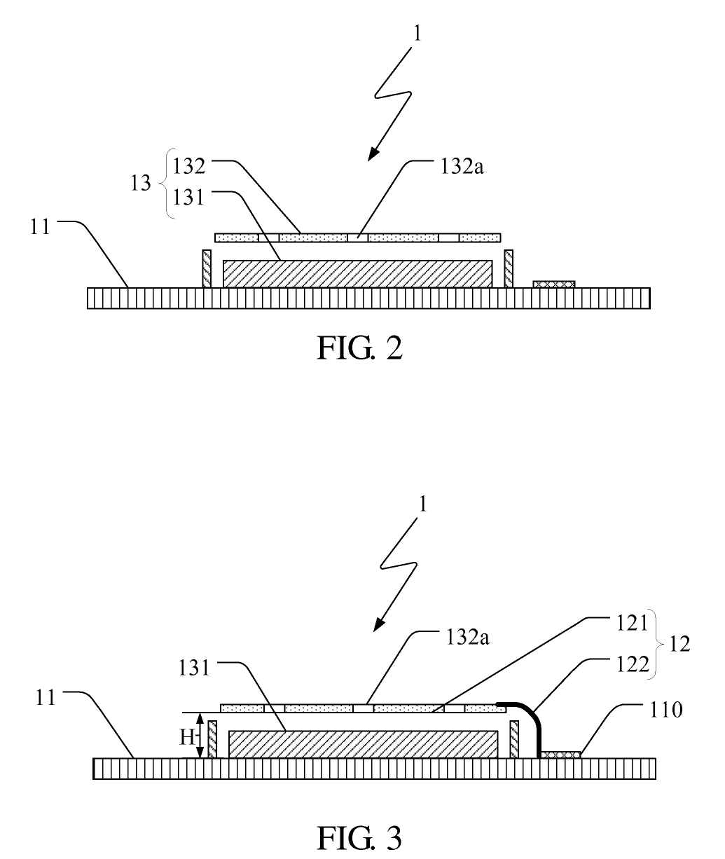

FIG. 1 is a partial top view of the interior of a portable electronic device 1 according to this invention, and FIG. 2 is a partial cross-sectional view of a speaker 13 in the portable electronic device 1 taken along line S-S′ shown in FIG. 1. It should be noted that the portable electronic device 1 disclosed in this invention may be, for example but not limited to, a mobile phone, a personal digital assistant (PDA), a global positioning system (GPS) device, or an electronic device incorporating a combination thereof. Since this invention primarily improves the antenna module in portable electronic devices, other elements of the portable electronic device that are unrelated to this invention will be omitted from the following descriptions.

In particular, the portable electronic device 1 of this invention comprises a circuit board 11, an antenna module 12 and a speaker 13 disposed on the circuit board 11. For example, in a common portable electronic device 1, the speaker 13 thereof generally has at least one driver unit 131 and at least one metal shield 132, which is disposed above the driver unit 131 for protection of the driver unit 131 of the speaker 13. The metal shield 132 has a plurality of sound apertures 132a adapted to propagate the sound emitted from the driver unit 13 to the exterior.

Furthermore, the antenna module 12 of the portable electronic device 1 of this invention comprises a main portion 121 and a connecting portion 122. As one of the characteristics of this invention, at least one portion of the metal shield 132 of the conventional speaker 13 is used as the main portion 121 of the antenna module 12 to transmit and receive various communication signals. This will save the cost of both the antenna module 12 and the receiving space required in the portable electronic device 1. Therefore, the current tendency towards a thin and lightweight portable electronic device is achieved. Moreover, by using the metal shield 132 as the main portion 121 of the antenna module 12, the antenna module 12 of this invention has an increased efficiency and a higher gain compared to the conventional ceramic chip antennas.

Specifically, the metal shield 132 of the speaker 13 comprises the main portion 121 of the antenna module 12, while the connecting portion 122 electrically connects a circuit 110 on the circuit board 11 and the metal shield 132. That is, the main portion 121 employs the metal shield 132 as the primary medium in the antenna module 12 to transmit and receive various communication signals. Such signals are adapted to be transmitted between the circuit 110 on the circuit board 11 and the metal shield 132. For description, an example in which the speaker 13 has only a single driver unit 131 and a single metal shield 132 will be described hereinafter. However, those of ordinary skill in the art will readily appreciate that this invention may further have a plurality of driver units 131 and a plurality of metal shields 132. Some or all of the metal shields 132 may be applied to antenna modules used for various communication modules.

FIG. 3 illustrates a partial cross-sectional view of the antenna module 12 taken along line S-S′ shown in FIG. 1. Specifically, the main portion 121 comprises at least one portion of the metal shield 132, which is used as the primary portion for transmitting and receiving signals in the antenna module 12. It should be noted that other elements of the speaker 13, such as those used to fix the metal shield 132 onto the circuit board 11, impose no impact on the efficiency of the antenna and thus will not be described herein. In other embodiments, the main portion of the antenna module of this invention may use the whole metal shield 132 to further improve the performance of the antenna in transmitting/receiving signals.

In the preferred embodiment, the main portion 121 of the antenna module of this invention is preferably located on an edge area 111 of the surface of the circuit board 11 as shown in FIG. 1, so that various communications signals transmitted by the antenna module 12 will not be shielded by the circuit board 11, thereby further improving the performances of the antenna. Additionally, the material of the metal shield 132 typically comprises aluminum. The stability and the electrical characteristics of aluminum are better than those of ceramics used in the ceramic chip antennas, thereby allowing the metal shield 132 to be used directly as the main portion 121 of the antenna module 12 for transmitting and receiving various signals.

Secondly, the connecting portion 122 of the antenna module 12 electrically connects the metal shield 132 and the circuit board 11. The connecting portion 122 may be a metal resilient flake containing copper, the resilience of which forces the metal resilient flake to touch the metal shield 132. Alternatively, the metal resilient flake is electrically connected to the metal shield 132 by welding, thereby functioning as the feeder of the antenna module 12. The feeder of the antenna module 12 is used to feed the communication signals into the main portion 121 (the metal shield 132) of the antenna module 12 to transmit the communication signals, or to transfer the various communication signals received by the main portion 121 (the metal shield 132) to the circuit 110 via the connecting portion 122. Preferably, the connecting portion 122 is formed at the side of the main portion 121 (the metal shield 132), and located on the edge area 111 of the circuit board 11, so that the communications signals transmitted from the antenna module 12 are substantially free from the impact of the circuit board 11. It should be noted that the metal resilient flake described above is merely one embodiment of the connecting portion. In practice, any similar elements that can accomplish an electrical connection may be adopted in this invention.

In the first embodiment of this invention, the antenna module 12 is a patch antenna module. As shown in both FIGS. 1 and 3, the main portion 121 is disposed at a height H from a plane of the circuit board 11, with the height H substantially ranging from 2 mm to 8 mm. In this way, the signal transmitted from the antenna module 12 is less likely to be interfered by the circuit board. Furthermore, the main portion 121 may be substantially shaped into a rectangle, although it is not just limited thereto. The rectangular main portion 121 has a characteristic length L and a characteristic width W, both of which are associated with the performance of the antenna module in transmitting the communication signals. In this embodiment, the antenna module 12 of this invention is used for Bluetooth and WLAN communication modules. To cater for the frequency bands allocated for Bluetooth and WLAM communications (2.4 GHz˜2.5 GHz) and to satisfy the prerequisite of the signal resonance in which the length of the current flow path of the patch antenna module needs to be one half of the signal wavelength, the characteristic length L substantially ranges from 13 mm to 18 mm, while the characteristic width W substantially ranges from 10 mm to 13 mm. In practical application, the height H is substantially 8 mm, the characteristic length L and the characteristic width W are substantially 18 mm and 13 mm, respectively. It should be noted that, in other examples, the main portion 121 may also be shaped into a circle, an ellipse, a polygon or a curved form, as long as it is sized in such a way that the current flow path matches the prerequisite of the communication frequency band.

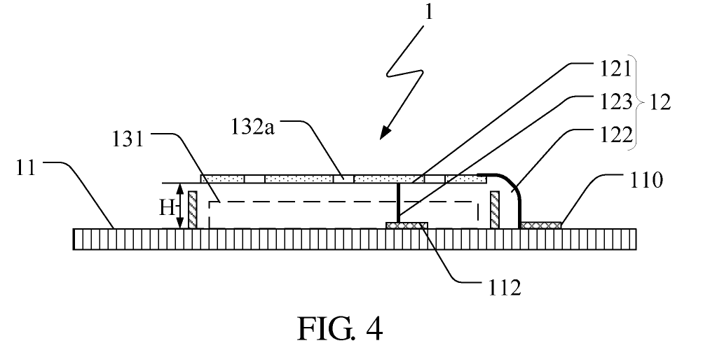

In another embodiment, the antenna module 12 of this invention may also be a planar inverted-F antenna (PIFA) module. In reference to FIG. 4, when the metal shield 132 is applied to a PIFA module, the antenna module 12 has to further comprise a ground portion 123, which electrically connects the main portion 121 and a grounding element 112 of the circuit board 11. Since the length of the current flow path of the PIFA module shall be one fourth of the signal wavelength to excite the signal resonance, the characteristic length L and the characteristic width W are decreased accordingly when the antenna module 12 is applied in the same communication frequency band.

In other examples, if the main portion 121 protrudes from the edge area 111 of the circuit board 11, the antenna module 12 of this invention may also be used as a monopole antenna module. In this case, the length of the current flow path thereof also has to be one half of the signal wavelength to excite the signal resonance. However, as can be appreciated by those skilled in the art, the application of the antenna module 12 is not just limited to the Bluetooth and WLAN communication modules. When the antenna module of this invention is applied to the different communication protocols, only the dimensions thereof need to be adjusted according to the communication frequency bands of the corresponding communication modules.

The design rules concerning the preferred ranges of the characteristic length L, the characteristic width W and the height H in actual products are listed in a table below with respect to the different communication frequency bands and different types of antennas. In this table, L-band represents a band used for digital video broadcasting (DVB). A frequency band allocated for a Global Positioning System (GPS) is also listed therein.

| | Type of antenna | | |
|---|---|---|---|
| Frequency band | Patch antenna | PIFA | Monopole antenna |
| BT&WLAN | L: 13~18 mm | L: 12~25 mm | L: 14~20 mm |
| (2.4~2.5 GHz) | W: 10~13 mm | W: 2~4 mm | W: 1 mm |
| | H: 2~8 mm | H: 3~8 mm | |
| L-band& DVB | L: 14~25 mm | L: 14~25 mm | |
| (1.67~1.68 GHz) | W: 12~16 mm | W: 2~12 mm | |
| | H: 4~8 mm | H: 3~8 mm | |
| GPS | L: 15~25 mm | L: 15~30 mm | |
| (1.575 GHz) | W: 15~25 mm | W: 3~15 mm | |
| | H: 4~6 mm | H: 3~8 mm | |

In conclusion, by using a metal shield that must be used in the speaker as the main portion of the antenna module described above, this invention saves both the manufacturing cost and material cost of the main portion. The portable electronic device employing the antenna of the present invention saves significant receiving space, thus makes it easier to produce a thin, slim and lightweight device; in addition, it also eliminates the aforesaid disadvantages suffered by conventional antennas. As a result, the competitiveness of the portable electronic device employing this antenna module is enhanced.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An antenna module for a portable electronic device, wherein the portable electronic device comprises a circuit board and a speaker, and the speaker is disposed on the circuit board and comprises at least one driver unit and at least one metal shield disposed above the at least one driver unit, the antenna module comprising:
a main portion, comprising at least one portion of the at least one metal shield; and
a connecting portion, electrically connecting the at least one metal shield and the circuit board.

2. The antenna module as claimed in claim 1, wherein the speaker has a driver unit and a metal shield disposed above the driver unit, and the main portion is the entire metal shield.

3. The antenna module as claimed in claim 2, wherein the connecting portion is formed at a side of the main portion as a feeder for the antenna module.

4. The antenna module as claimed in claim 3, wherein the main portion is located on an edge area of a surface of the circuit board.

5. The antenna module as claimed in claim 4, wherein the feeder is located on the edge area of the circuit board.

6. The antenna module as claimed in claim 1, wherein the antenna module is a Patch Antenna.

7. The antenna module as claimed in claim 6, wherein a height of the main portion with respect to the circuit board is substantially between 2 mm and 8 mm.

8. The antenna module as claimed in claim 7, wherein the main portion is configured in a rectangle substantially defined to have a characteristic length and a characteristic width, in which the characteristic length is substantially between 13 mm and 18 mm, and the characteristic width is substantially between 10 mm and 13 mm.

9. The antenna module as claimed in claim 1, further comprising a ground portion electrically connecting the main portion and a grounding element of the circuit board.

10. The antenna module as claimed in claim 9, wherein the antenna module is a planar inverted F antenna.

11. The antenna module as claimed in claim 1, wherein the material of the at least one metal shield comprises Aluminum.

12. The antenna module as claimed in claim 3, wherein the material of the connecting portion comprises Copper.

13. A speaker for a portable electronic device, wherein the portable electronic device comprises a circuit board and an antenna module, the antenna module comprises a main portion and a connecting portion, wherein the connecting portion electrically connects the main portion and the circuit board, and the speaker is disposed on the circuit board and comprises:
at least one driver unit; and
at least one metal shield, disposed above the at least one driver unit and comprising the main portion.

14. A portable electronic device, comprising the antenna module as claimed in claim 1.
